(19) United States
(12) Patent Application Publication
(10) Pub. No.: US 2023/0202642 A1
(43) Pub. Date: Jun. 29, 2023

(54) AIRCRAFT NOISE CONTROL

(71) Applicant: DE HAVILLAND AIRCRAFT OF CANADA LIMITED, Mississauga (CA)

(72) Inventor: Thineshan KATHIRCHELVAN, Markham (CA)

(21) Appl. No.: 18/062,190

(22) Filed: Dec. 6, 2022

(30) Foreign Application Priority Data
Dec. 23, 2021 (CA) 3141189

(51) Int. Cl. B64C 1/40; G10K 11/168; B32B 5/18; B32B 27/40; B32B 27/06

(52) U.S. Cl. CPC B64C 1/40; B32B 5/18; B32B 27/40; B32B 27/065; G10K 11/168; B64D 29/00

(57) ABSTRACT

A use of a sheet material including a laminate of a first layer of a resilient polymer and a membrane outwardly of the first layer, the membrane being a polymer harder than the resilient polymer, for application to an exterior surface of an aircraft fuselage for noise reduction within the cabin. A method for mitigating vibroacoustic noise in a passenger cabin of an aircraft having a fuselage, the method comprising: coating a portion of an exterior surface of the fuselage with a resilient sheet material.

### TECHNICAL FIELD

The present invention relates to apparatus and methods for aircraft noise control.

### BACKGROUND

Induced noise is a problem for aircraft. Turbulent boundary layer (TBL) noise as well as propeller induced higher harmonic tones are of concern in the industry especially in the cabin of passenger aircraft.

The dominant noise source on a propeller-driven aircraft arises from the blade passing frequency of the propeller and its harmonics. This introduces strong tonal peaks in the noise signature.

However, one of the main contributors of broadband noise above 500 Hz is the aerodynamic flow over the fuselage. This flow introduces high frequency pressure fluctuations on the outer skin of the aircraft that could transmit into the cabin as TBL noise.

The energy distribution of TBL noise is a function of airspeed and altitude and typically the acoustic energy content is concentrated between 500 to 2000 Hz. At a given altitude, higher airspeed also increases the acoustic pressure amplitude of this broadband noise.

In prior solutions, (i) porous insulation was added between the fuselage and the interior shell, (ii) isolators were installed between the fuselage and the interior shell and/or (iii) skin damping was introduced on the interior side of the fuselage in pockets in the frames and the stringers.

Such solutions are all internal and requires a significant amount of mass to reduce noise by a few decibels (dB). Also, unlike the ceiling and sidewall, it is difficult, if not impossible, to isolate the cabin floorboards and seats from the fuselage structure due to safety concerns. It is also difficult to achieve a global coverage that includes the frames and the stringers. As such, there remain flanking (i.e. leak) paths that serve as short circuit for vibratory transmission which ultimately results in radiated noise into the cabin.

Current solutions such as aircraft active noise and vibration suppression systems may not target higher frequency, random noise which is an essential characteristic of aerodynamic noise.

Therefore, there remains a need for an aircraft noise control solution that addresses turbulent boundary layer and possibly propeller induced noise in the cabin.

### SUMMARY OF THE INVENTION

In accordance with broad aspects of the present invention, there is provided apparatus and methods for aircraft noise control.

In accordance with a broad aspect of the present invention, there is provided a use of a sheet material including a laminate of a first layer of a resilient polymer and a membrane outwardly of the first layer, the membrane being a polymer harder than the resilient polymer, for application to an exterior surface of an aircraft fuselage for noise reduction within the cabin.

In accordance with another broad aspect of the present invention, there is provided a method for mitigating vibroacoustic noise in a passenger cabin of an aircraft having a fuselage, the method comprising: coating a portion of an exterior surface of the fuselage with a resilient sheet material.

In accordance with another broad aspect of the present invention, there is provided an aircraft comprising: a fuselage with an exterior surface; a passenger cabin, a cockpit and a wall between the passenger cabin and the cockpit within the fuselage; and a resilient sheet material coupled to the fuselage exterior surface, wherein the resilient sheet material damps turbulent boundary layer and/or propeller-induced noise within the passenger cabin.

In accordance with another broad aspect of the present invention, there is provided an acoustic-damping sheet material comprising: a laminate of (a) a first layer of a resilient polymer; and (b) a membrane outwardly of the first layer, the membrane being a polymer harder than the resilient polymer; and, the acoustic-damping sheet material being for application to an exterior surface of an aircraft fuselage for acoustic-damping within the cabin.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all within the present invention. Furthermore, the various embodiments described may be combined, mutatis mutandis, with other embodiments described herein. Accordingly, the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

FIG. 1 is a sectional view through an example resilient sheet material useful for vibroacoustic-damping in an aircraft fuselage;

FIG. 2a is a side elevation of an aircraft with a vibroacoustic-damping exterior treatment;

FIG. 2b is an elevation of the opposite side of the aircraft of FIG. 2a;

FIG. 2c is a side elevation of a turboprop aircraft nacelle with a vibroacoustic-damping exterior treatment;

FIG. 3 is a side elevation of another aircraft with a vibroacoustic-damping exterior treatment;

FIG. 4 is an enlarged side elevation of another vibroacoustic-damping exterior treatment;

FIG. 5 is a graph comparing a noise difference between treated and untreated aircraft; and

FIG. 6 is a graph comparing average damping loss factor between an untreated fuselage section and a treated fuselage section.

### DETAILED DESCRIPTION OF EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

A solution has been invented for noise control in an aircraft.

Turbulent boundary layer and, if necessary, propeller induced noise can be reduced in the cabin by an external application of a resilient material on the fuselage. While other solutions have applied insulation or isolators to the interior of the fuselage, this solution couples the noise mitigation material onto the exterior of the fuselage. The applied material is resilient and can be coupled to selected areas of the exterior surface of the fuselage.

The resilient material acts as a noise reduction layer that can be evenly distributed over selected areas on the fuselage external skin. An external application is believed to improve efficiency in two ways:
(a) the application broadly covers the fuselage structure from the external side and therefore mitigates vibration transmission to the skin pockets, the frames, the stringers, the frame flanges, as well as the stringer flanges and
(b) acts on the external side which is also the side of the force excitation (i.e., aerodynamic flow, propeller induced aerodynamic wash, etc.)

It is believed that the material acts to convert mechanical energy into other forms, including to thermal energy, to effectively reduce the noise radiation. Lab testing has confirmed that this resilient material when applied to a large sample of an aircraft fuselage increases the damping loss factor (DLF) relative to an untreated section. Due to its external application, the material may also help mitigate impact noise from small turbulent boundary layer structures by acting as a soft contact as opposed to a harder contact that would be otherwise present.

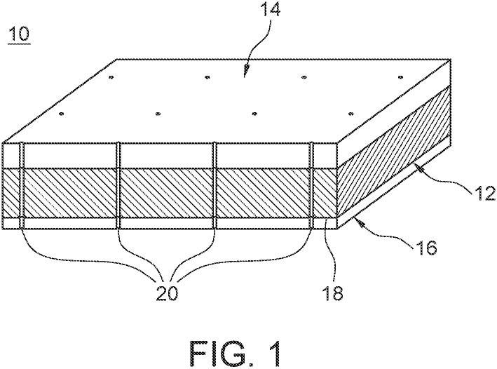

The resilient material may be a resilient sheet material such as an adhesive film, which may alternatively be termed a tape. With reference to FIG. 1, the resilient sheet material 10 may include a rear side 18 that will be coupled against the fuselage outer surface and an exposed side, which is opposite the rear side. The material is resilient, but must also be durable and resistant to damage by impact. A sheet material manufactured from one or more polymers is of interest including an exposed layer of a first polymer and an underlying layer of second polymer, the second polymer selected to be more compressible and resilient than the first polymer. Such a material includes a rear side polymeric layer, which acts as a resilient member 12 and an exposed surface layer 14, which acts as a membrane and/or mass on the resilient layer, when applied to the external body of an aircraft.

In one aspect, a sheet material includes a laminate of pressure sensitive acrylic on the rear side and an overlying membrane, also called a “coating”, of polyurethane on the exposed side. The acrylic is configured to be more compressible and resilient than the polyurethane. In one aspect shown in FIG. 1, a sheet material 10 is useful that where the rear layer 12 is acrylic foam and membrane 14 is polyurethane. For example, a 0.005 to 0.100 inch, for example, 0.020 to 0.030 inch (about 0.5 to 0.8 mm) thick layer of acrylic foam covered with a 0.005 to 0.064 inch (0.13 to 1.0 mm), about 0.010 to 0.025 inch, thick polyurethane membrane. The sheet material may be self-adhering or require application of the sheet material. In one aspect, the sheet material inner layer, for example, the acrylic foam, acts as a durable pressure sensitive adhesive on the rear side. It should be understood that other numbers of layers are possible and other thicknesses are possible.

The sheet material should be lightweight, as weight considerations are always of concern. The sheet material could be less than 3 lbs or possibly less than 2.5 lbs per yard².

Such a material has been found to be adequate to dampen typical aerodynamic and propeller induced cabin noise in an aircraft. The resilient sheet material provides a solution to reducing cabin noise that arises at a broadband frequency range and can be used to target turbulent boundary layer noise amongst other externally inputted noise sources such as the higher harmonics of a propeller. The present noise mitigation solution is broadly applicable to any aircraft, including jets, turboprops, commercial and business aircraft.

The material composition can also be varied to initiate the performance benefit at lower cut-on noise frequencies as well as to fine tune for lower temperatures by varying the polymers and for example replacing the pressure sensitive acrylic foam and/or the polyurethane with other materials or different thicknesses.

One useful sheet material is known as 3M™ Protective Tape, or specifically 3M™ Aircraft Belly Protective Tape 8641 available from 3M Company, St. Paul, Minnesota. With reference to FIG. 1, the sheet material 10 available as 3M tape 8641 includes a resilient 0.025” thick pressure sensitive acrylic foam 12 coated with a 0.016” thick UV-resistant polyurethane 14. The film is perforated with 10 mil holes 20 that are spaced ¼” apart. The acrylic foam has pressure sensitive adhesive properties or has an adhesive applied on the rear side. The tape may have a peel off liner 16, for example a polyurethane liner, on the rear side 18. The 8641 tape material has been intended for use to protect the fuselage skin from gravel splashes purely from a damage perspective. While this sheet material has been used as a protective film, for example, for mitigating impact damage, as by gravel, the applicant has now determined that a resilient sheet material with a resilient layer and a mass/membrane layer, such as 8641 tape, is useful for mitigation of cabin noise in aircraft.

The sheet material can be applied anywhere on the exterior of the fuselage. Belly applications are particularly useful since, while TBL noise is induced all around the fuselage, the main flanking paths are via the belly because the floorboards and seats are not isolated like the ceiling panels and sidewall panels are. So analogously the sheet material applied on the belly is closing the open gate on the bottom side through which vibration transmission occurs.

Application on the external body allows for coverage of frames, stringers, and other elements that would not be possible with internal skin application that is prone to vibroacoustic “leaks”. It is also easier to apply this on aircraft that are already in service because you don’t have to dismantle the interior.

The sheet material can also be wrapped over parts such as doors, panels, etc. The sheet material can also be underlapped between exterior components, for example, the sheet material can be extended from the exterior into the well over which a door or panel extends to address rattle issues between the parts. Noise will be reduced inside the aircraft anywhere the sheet material is applied over, compared to the noise that would be experienced in that same area without the resilient sheet material covering.

The sheet material is applied over the exterior surface including over panel seams and rivets. The sheets may be in manageable sheet sizes, such as 12 inches to 5 feet wide, and may come on long rolls. A number of sheets, for example cut from the roll, may be required to cover the selected fuselage area.

Adjacent sheets may be overlapped with the fore edge of one sheet overlapped by the aft edge of the next sheet. Overlap areas may be treated, for example, roughed, primed or coated, to ensure sufficient adhesion. Holes can be cut for vent holes, access panels, etc.

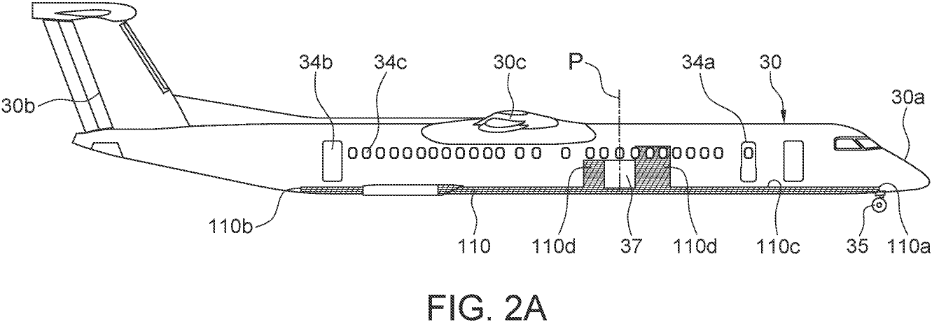

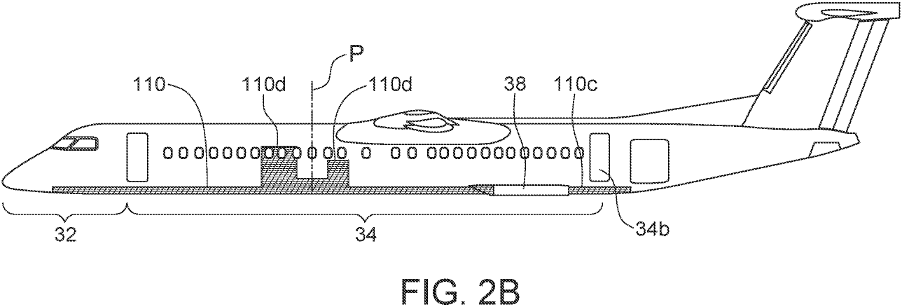

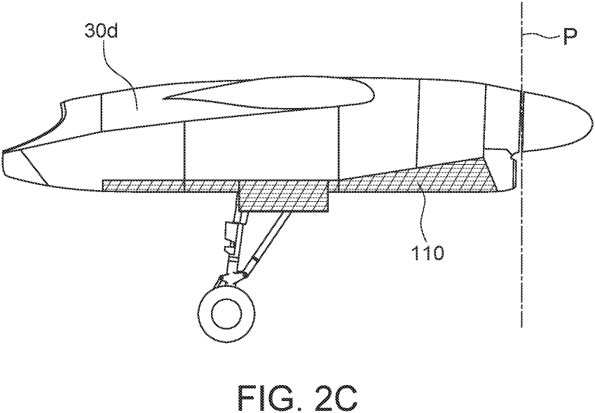

It will be appreciated that an aircraft, such as the illustrated turboprop aircraft of FIGS. 2a to 2c, has a fuselage 30 that defines a nose 30a and a tail section 30b. The aircraft further includes wings 30c and nacelles 30d (FIG. 2c). In a turboprop aircraft, the propellers are positioned on the nacelles with blades that rotate in a plane P.

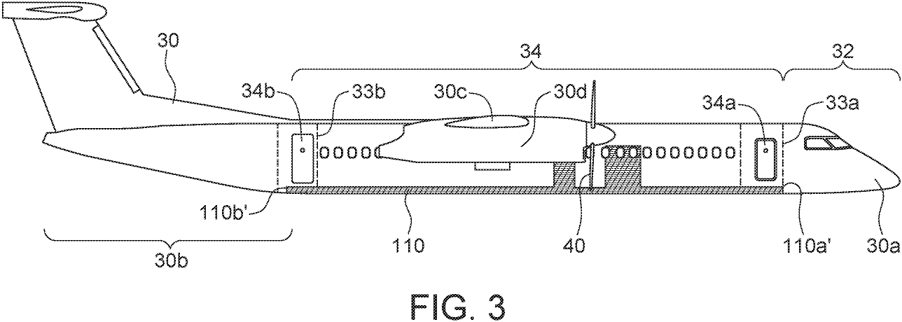

A passenger aircraft has an interior with a clearly delineated cockpit 32 and cabin 34, usually with a wall 33a (FIG. 3) between them. The passenger aircraft includes a seating area within the cabin, accessed by a forward passenger entry door 34a and a rear cabin door 34b. Usually, the seating area includes windows 34c.

The exterior surface of the fuselage may have coupled thereto an ice shield 37 and strakes 38. An ice shield is a bumper like structure installed in the plane of the propellers to take hits and protect the fuselage.

In one embodiment, an aircraft with improved noise properties includes the resilient sheet material applied on the underside of the aircraft to the black areas noted in FIGS. 2a to 2c. In particular, the sheet material 110 covers the underside of the fuselage 30 from a fore position 110a under the cockpit 32 to an aft position 110b adjacent the tail 30b. For example, the sheet material can be aligned with the nose gear 35, wherein the fore position can be at or within 6 feet of the nose gear door. The aft position 110b may be near the tail, for example, at, or within 2 feet in front of, the rear ramp door. On the sides, the sheet material 110 extends from a side limit 110c near the chine, which is below the lower sills of the doors 34a, 34b, on one side to an opposite side limit 110c on the other side, which is near the chine / below the lower sill of the door 34b. To be clear, a chine is a longitudinal line of sharp change in the cross-section profile of the fuselage or similar body.

In some areas 110d, the sheet material can be extended up further on one or both sides of the aircraft. For example, in those side extension areas 110d the upper edge of the sheet material is above the lower sills of the doors 34a, 34b, and closer to or above the windows 34c.

In one embodiment, as shown in FIGS. 2a - 2c, a Dash 8-400™ turboprop aircraft, available from De Havilland Aircraft of Canada Limited, Toronto, Ontario has an vibroacoustic noise mitigating covering of sheet material 110, as follows:
A front position 110a aligns with the position of the nose landing gear wheel 35, which has a station location at X = -82 to -130 or about -106 inches (X = station location = the position along the long axis of the aircraft where a position at or near the front of the front galley area is X = 0 inches for example, in one configuration X = the front edge of the front entry door);
An aft position 110b is slightly aft of the aft cabin doors 36b, which is at the transition from fuselage to tail cone. This is a station position of X = 704 to 752 or about 728 inches;
The material covers the lower surface of the main fuselage, such that the tape extends from the bottom most point of the fuselage to primary side limit 110c on each side of the fuselage where the Z position coordinate projection is 35″ above the bottom most point (Z position is the dimension from the bottom most point of the fuselage);
Sheet material is applied over the entire lower surface of strake 38 and over the upper surface thereof near the outboard leading edge;
Symmetrically on both sides, there is a side extension 110d forward of the propeller plane P. The forward edge of this forward side extension is at X = 172 to 220 or about 196 inches, which is four windows forward of the propeller plane. This patch of forward side extension 110d terminates at a position two and a half windows aft of the starting position, which is at the leading edge of the ice shield 37. The forward side extension material extends up to a point up to 6 inches, for example about 3 inches, above the windows; and
Symmetrically on both sides, there is an extended patch of sheet material attached as side extension 110d aft of the propeller plane P. The forward edge of this aft side extension is at the trailing edge of the ice shield 37 and it extends back through one and a half windows to X = 297 to 345 or about 321 inches. The aft side extension material extends up to a point just below, about 1 to 6 inches or about 3 inches below the windows. In this embodiment, sheet material 110 is applied to the fuselage adjacent to the edges of the ice shield so but there is no sheet material coverage over or under the ice shield.

In addition, the sheet material 110 is attached to the underside of the nacelles, as shown in FIG. 2c.

The application of FIGS. 2a to 2c, using a sheet material according to FIG. 1, adds a total weight of about 136 lbs to a Dash 8-400 turboprop aircraft. This aircraft has significantly improved noise characteristics over an untreated aircraft (see the examples).

With reference to FIG. 3, another aircraft with improved noise properties includes the resilient sheet material applied on the exterior underside of the aircraft fuselage substantially only along the passenger cabin 34. In particular, the resilient sheet material is not coupled (i) on the nose 30a under the cockpit 32, (ii) on the tail 30b aft of the cabin rear wall (iii) on the wings 30c or nacelles 30d. In particular, the sheet material 110 covers the exterior underside of the main fuselage 30 from a fore position 110a′ to an aft position 110b′. The fore position 110a′ is radially outwardly from or rear of the cockpit door wall (shown in phantom 33a, X = between -40 and 0 +/- 24 inches) or radially outwardly from or rear of the front passenger entry door 34a (X = between 0 and 32 +/-24 inches) or radially outwardly from or rear of the bulkhead (shown in phantom X = between 32 +/- 24 inches) between the front passenger entry door and the front-most seat. Selecting the fore position 110a′ to be at 33a, which is radially outwardly from the cockpit door wall, positions the damping material at a clear point where the passengers are located. And it also ensures that there is no hotspot for noise radiation in front of the passengers which may be audible in the first few rows.

The aft position 110b′ is at or forward of the cabin rear wall (X = 701 +/- 24 inches), at about the rear galley, or radially outwardly from or forward of the rear bulkhead 33b (shown in phantom, X = >63 for example 667 +/- 24 inches), which is between the rearmost seat and the rear galley and rear cabin doors 34b.

In the foregoing, it is to be understood that the X coordinates are those from a typical Dash 8-400™ turboprop aircraft and are provided only to more clearly identify the cabin structures.

When referencing “radially outwardly of”, it is to be understood that any structure (i.e. an entry door) in an aircraft has an axial position along the fore to aft long axis (i.e. axial length) of the fuselage and “radially outwardly from” means at about the same axial position as the specified structure. In other words, considering the long axis of the aircraft from nose to tail, the noise damping material will be coupled to the fuselage’s exterior surface at a position along the long axis that is radially outwardly from, including orthogonally below, the axial position of the noted structure, but substantially will not extend beyond an orthogonal section through the fuselage at that position. For example, when referencing the wall between the cockpit and the front passenger entry door, the wall’s planar expanse defines a plane, for example a substantially orthogonal plane, relative to the long axis of the fuselage and reference to the resilient sheet material being coupled “radially outwardly from” the wall means “in substantially the same orthogonal plane” of that wall. That positioning could be on the underside, sides or top of the fuselage not just under.

In one embodiment, the resilient sheet material 110, such as one according the material described above, is applied on the exterior underside of the fuselage, only along the length from about the axial location of the cockpit wall 33a back along the full length of the fuselage that accommodates the passenger seats (i.e. the length with windows) to bulkhead 33b. The fuselage exterior surface forward of the cockpit wall 33a and aft of the length accommodating the passenger seats is free of resilient sheet material of the type used for material 110 around the passenger seat area. Possibly the sheet material can be added with some margin in front and aft to avoid creation of a hotspot that is still audible to passengers sitting behind or in front the ends of the section over which the noise mitigation material is applied. As illustrated, the nacelles 30d are free of resilient sheet material of that type used for noise mitigation material 110.

It will be appreciated that the sheet material 110 in FIG. 3, is only applied where it is most needed to mitigate cabin noise, which impacts the customer experience. Cost and weight advantages are achieved by limiting the exterior surface area covered with the sheet material. For example, while the acoustic-mitigation solution of FIGS. 2a-2c adds a total weight of about 136 lbs to a Dash 8-400™ turboprop aircraft, the acoustic-mitigation solution of FIG. 3, which omits material application on the nacelles and on the front and aft sections, adds only about 100 lbs to the weight of a Dash 8-400™ turboprop aircraft.

In a further embodiment, the material can be optimized for further noise reduction to cover strategic locations of the fuselage. For example, a lot of noise is generated by the engines and propellers. In one aspect, therefore, an amount of resilient sheet material is coupled on the outer surface of the fuselage around the cabin from an axial position forward of the engine to a position axially aft of the engine and from a position below the horizontal plane of the engine, for example all the way under the aircraft belly, to a position above the horizontal plane of the engine, for example a position above the windows. The resilient sheet material can cover the fuselage even where ice-shield 37 is located. The ice-shield can be installed on top of, or can be coated with, the resilient sheet material.

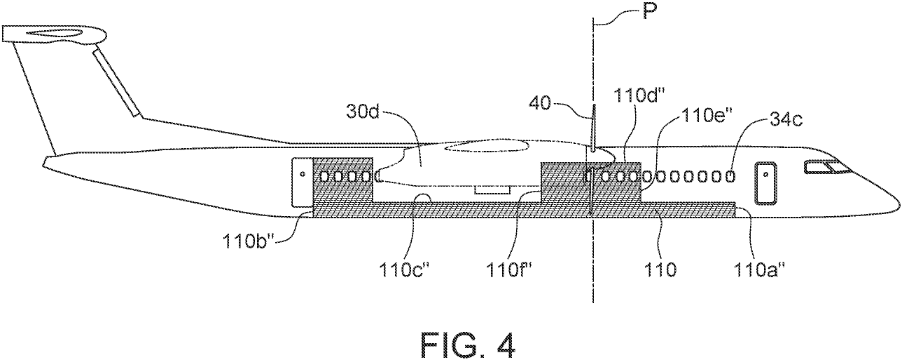

For example, in a turboprop aircraft as illustrated in FIG. 4, a lot of noise is generated from the engines and the propellers 40. It can be particularly noisy in the cabin, at an axial position within or near the plane P defined as the plane in which the propeller blades rotate. This plane is generally orthogonal to the long axis of the fuselage at the axial location of the propeller blades. In such an embodiment, an amount of resilient sheet material 110 can be applied between a forward limit 110″ and a rear limit 110b″ over the aircraft belly up to a regular side positions 110c″. Additionally, an amount of sheet material can be applied higher up on the sides of the aircraft to cover the fuselage 30 exterior surface in a position to span the propeller plane, for example, from an axial position 110e″ forward of the propeller plane back to a position 110f″ aft of the propeller plane. The nacelles 30d are shown in phantom so the side of the aircraft can be seen. The sheet material can extend from position 110e″ to 110f″ continuously without a gap, such as the gap shown in FIG. 2A. This resilient sheet material in this specific area between 110e″ and 110f″ can extend from the lower center line, fully under the belly of the aircraft, to a side position 110d″ at a horizontal plane passing through or above the windows. Possibly, the sheet material may be attached fully over the top of the fuselage from one side to the other.

While the fuselage exterior surface area directly radially out from, or bisected by, the plane P of the propellers normally has an ice-shield applied thereto, the resilient sheet material 110 can cover the fuselage even where ice-shield is normally located. The ice-shield can be applied on top of the resilient sheet material or the resilient sheet material for the extension can be applied over the ice shield.

The propellers do not spin symmetrically on the left and right side. Therefore, the aerodynamic propeller wash hits the top of the fuselage on one side and the bottom of the fuselage on the opposite side. Therefore, the resilient sheet material need not be symmetrically applied on the two sides, relative to the center line. In one embodiment, for example, the left hand side of the fuselage may have a patch of resilient sheet material coupled to address upper propeller wash and the right hand side of the fuselage may have a patch of resilient sheet material coupled to address lower propeller wash.

In addition, there may be secondary propeller wash noise near the rear of the passenger cabin. In one aspect, therefore, there is a further side extension 110g that is coupled over the exterior fuselage from about the last three or four windows 34c to address noise concerns in the last three or four rows of seats just before the rear bulkhead. That extension extends up at least to or above the windows.

The seats between the rear limit 110f″ and the forward edge of extension 110g tend not to receive propeller wash noise and therefore, the sheet material can be stopped below the horizontal line of the door sills, which is still addresses noise transmission from the fuselage through the floor.

The resilient material can be cut to avoid covering the wings and nacelle 30d.

In such an embodiment, if desired, an additional portion of the resilient sheet material covering 110 can extend along the underside of the aircraft from a fore position 110a″ to an aft position 110b″.

In one embodiment, different material compositions can be employed in different areas of the fuselage. For example, in the embodiment of FIG. 4, a different composition of material can be applied in section 110e″ to 110f″ and section 110g to target the lower frequency noise of the propeller tone compared to the material used for the coverage between 110a″, 110b″ and 110c″.

A method for reconfiguring an aircraft with a noise mitigated solution can include adhering the resilient sheet material to a selected area of the fuselage exterior. The methods for adhering is according to the sheet material employed and the condition of the surface to which it is adhered. In one embodiment, using a sheet material according to FIG. 1, an application method suggested by the manufacturer includes:

Surface Preparation including:
(a) degreasing
(b) cleaning; and
(c) surface repair and surface roughening, if required;

Application including:
Remove all mounted lights, antennas, etc. in the area of interest to provide a flat installation area. These areas may be trimmed free of tape after installation and parts reinstalled.
Apply a suitable primer, for example 3M™ Adhesion Promoter 86A, to the fuselage along the edges of the selected area.
The sheet material will be installed front to rear, from side to side. In so doing, measure and precut the sheet material with allowances for overlap of chine on each side. Remove the liner and squeegee the sheet material in place, working from the aircraft centerline out toward the chines.
Where there is overlap between the sheets, scuff the edge of the applied sheet with an abrasive pad, clean with a solvent such as isopropanol or, if available, methylethylketone (MEK is preferred because it slightly “bites” into the polyurethane surface) and allow to dry. Then apply an even coat of primer and allow to dry before applying the overlapping edge.
Seal the leading edges 110a, 110a′, 110a″ and side edges 110c, 110d, well in order to avoid peeling.

### EXAMPLES

The following examples are provided to assist with understanding, but are not to be taken to limit the invention, unless the applicant so indicates:

### Example I

Dash 8-400 aircraft with no acoustic-damping exterior sheet material (aircraft numbers A and B) were flight tested alongside a first Dash 8-400 (aircraft C) treated with 3M Aircraft Belly Protective Tape 8641 according to the treatment areas shown in FIGS. 2a-2c and a second Dash 8-400 (aircraft D) equipped with an interior lightweight acoustic package and treated with 3M Aircraft Belly Protective Tape 8641 as with aircraft C.

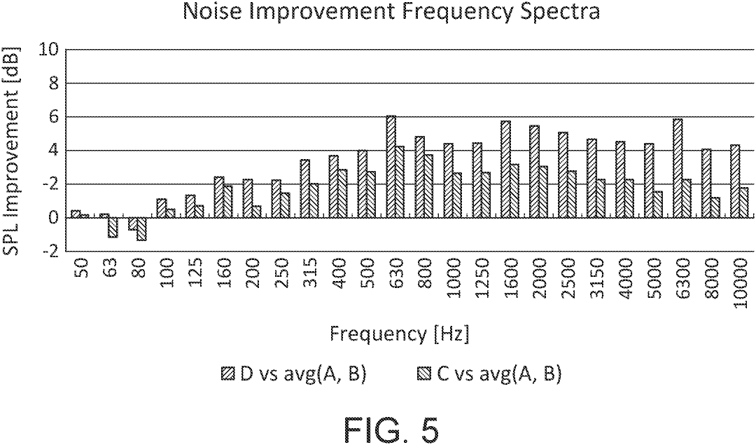

With reference to FIG. 5, flight testing confirmed that in treated aircraft overall cabin noise levels are 1.5-2 dBA lower on average at FL250 (Flight Level) and 210 KIAS (Knots Indicated Airspeed), when compared to untreated aircraft. Flight testing has shown that this material reduces the noise vs. airspeed slope resulting in an even higher benefit at higher airspeed at a given altitude. At 245 KIAS, the overall cabin noise level average is 2-2.5 dBA lower than the untreated aircraft. This result confirmed that the membrane of resilient sheet material provides a significant cabin noise reduction benefit.

### Example II

A study was conducted in the lab on Dash 8-400 fuselage section. Baseline studies were conducted on the fuselage section (without a membrane) and then the fuselage exterior surface was coated with a resilient sheet material (3M Aircraft Belly Protective Tape 8641) and tests were repeated.

The study focused on determining the mobility which is the relationship that governs how a dynamic force excitation is converted to surface velocity (as a function of frequency).

Accelerometers were mounted on the internal side of the fuselage and were not repositioned during the tests. In particular, seven uni-axial accelerometers were installed on the panel (2 on the skin, 2 on the rivet line, 1 on a corner, and 2 on the frame).

At each location, an impact hammer was used to input a broadband force excitation. The response was measured as velocity to determine the input mobility as well as transfer path mobilities. Furthermore, the impulse response acquired from the accelerometers was used to determine the damping loss factor (DLF) with and without the resilient sheet material to capture the intrinsic damping property of the sheet material.

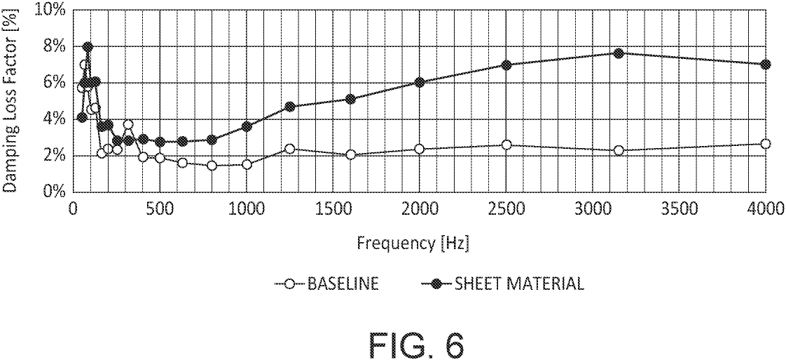

Based on the 245 impulse responses acquired for each condition, the average damping loss factor was calculated at each third octave frequency band. The results are charted in FIG. 6. With the resilient sheet material attached, the DLF is higher beginning at 400 Hz third octave band. The increase is more pronounced starting at 800 Hz.

Therefore, the DLF is significantly higher with the application of the resilient sheet material indicating that dynamic force excitations will are more rapidly dissipated as something other than mechanical vibration.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. Use of a sheet material including a laminate of a first layer of a resilient polymer and a membrane outwardly of the first layer, the membrane being a polymer harder than the resilient polymer, for application to an exterior surface of an aircraft fuselage for noise reduction within the cabin.

2. The use of claim 1 wherein the use applies the sheet material to only a portion of the aircraft fuselage extending from the location of the cockpit wall back along the passenger seating area.

3. The use of claim 1 wherein the use avoids application to the nacelles, the nose and the tail.

4. The use of claim 1 wherein the first layer is a 0.005 to 0.1 inch thick layer of acrylic foam and the membrane is a 0.005 to 0.064 inch thick polyurethane.

5. A method for mitigating vibroacoustic noise in a passenger cabin of an aircraft having a fuselage, the method comprising:
coating a portion of an exterior surface of the fuselage with a resilient sheet material.

6. The method of claim 5 wherein the portion is only from an axial position radially outwardly of a wall between the cockpit and a passenger area, back along the passenger seating area.

7. The method of claim 5 further comprising coating the exterior surface near windows to the passenger cabin and aligned with a plane of propeller rotation.

8. The method of claim 5, wherein coating avoids application of the resilient sheet material to the nacelles.

9. The method of claim 5, wherein the portion is above the windows.

10. The method of claim 5, wherein the coating step applies the resilient sheet material asymmetrically on one side of the aircraft compared to the other side of the aircraft.

11. An aircraft comprising:
a fuselage with an exterior surface;
a passenger cabin, a cockpit and a wall between the passenger cabin and the cockpit within the fuselage; and
a resilient sheet material coupled to the fuselage exterior surface, wherein the resilient sheet material damps turbulent boundary layer and/or propeller-induced noise within the passenger cabin.

12. The aircraft of claim 11 wherein the resilient sheet material is coupled only to an area aft of the cockpit.

13. The aircraft of claim 11 the resilient sheet material covers at least a portion of the fuselage exterior surface from a forward-most location radially outwardly from the wall and back along the passenger seating area.

14. The aircraft of claim 13 further wherein the portion is near windows to the passenger cabin and aligned within a propeller plane.

15. The aircraft of claim 11, wherein the nacelles are free of the resilient sheet material.

16. An acoustic-damping sheet material comprising:
a laminate of (a) a first layer of a resilient polymer; and (b) a membrane outwardly of the first layer, the membrane being a polymer harder than the resilient polymer; and,
the acoustic-damping sheet material being for application to an exterior surface of an aircraft fuselage for acoustic-damping within the cabin.

17. The acoustic-damping sheet material of claim 16 the first layer is a 0.005 to 0.1 inch thick layer of acrylic foam and the membrane is a 0.005 to 0.064 inch thick polyurethane, and adhesive properties are provided by the acrylic foam.
